(19) United States
(12) Patent Application Publication
(10) Pub. No.: US 2026/0084406 A1
(43) Pub. Date: Mar. 26, 2026

(54) SHAPE MORPHING STRUCTURES WITH SHAPE MEMORY POLYMER IMPREGNATED FABRICS

(71) Applicant: Toyota Motor Engineering & Manufacturing North America, Inc., Plano, TX (US)

(72) Inventors: Koray Benli, Ann Arbor, MI (US); Yuyang Song, Ann Arbor, MI (US); Umesh N. Gandhi, Farmington Hills, MI (US); Shinnosuke Shimokawa, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/895,860

(22) Filed: Sep. 25, 2024

(51) Int. Cl. B32B 27/12; B32B 3/26; B32B 5/02; C08J 5/24

(52) U.S. Cl. CPC B32B 27/12; B32B 3/266; B32B 5/02; C08J 5/24; B32B 2260/021; B32B 2260/046; B32B 2307/30

(57) ABSTRACT

A morphing load bearing structure includes an auxetic pattern sheet formed from a plurality of fabric panels selectively impregnated with a first shape memory polymer (SMP) with a first glass transition temperature and a second SMP with a second glass transition temperature different than the first glass transition temperature. The morphing load bearing structure also includes a sealing layer disposed on the auxetic pattern sheet such that the auxetic pattern sheet is configured to be inflated into a complex shape without a wrinkle.

### TECHNICAL FIELD

The present disclosure relates generally to morphing structures and particularly to morphing structures formed from fabrics.

### BACKGROUND

Morphing structures provide a range of services and functions. For example, structures that morph into a desired shape to support, hold, and/or resist movement of an object can be desirable. However, the complexity of such morphing structures can be more than desirable.

The present disclosure addresses the issue of complex morphing structures, and other issues related to morphing structures.

### SUMMARY

This section provides a general summary of the disclosure and is not a comprehensive disclosure of its full scope or all of its features.

In one form of the present disclosure, a morphing structure includes an auxetic pattern sheet formed from a plurality of fabric panels selectively impregnated with a first shape memory polymer (SMP) with a first glass transition temperature and a second SMP with a second glass transition temperature different than the first glass transition temperature. The morphing load bearing structure also includes a sealing layer disposed on the auxetic pattern sheet such that the auxetic pattern sheet is configured to be inflated into a complex shape without a wrinkle.

In another form of the present disclosure, a morphing structure includes an auxetic pattern sheet formed from a plurality of fabric panels selectively impregnated with a first shape memory polymer (SMP) with a first glass transition temperature and a second SMP with a second glass transition temperature different than the first glass transition temperature. The morphing load bearing structure also includes an elastomer sealing layer disposed on the auxetic pattern sheet such that the auxetic pattern sheet is configured to be inflated into a complex shape without a wrinkle and a bladder attached to the auxetic pattern sheet such that the auxetic pattern sheet with the bladder attached thereto is configured to contain a pressurized fluid therein.

In still another form of the present disclosure, a morphing load bearing structure includes an auxetic pattern sheet formed from a plurality of fabric panels selectively impregnated with a first shape memory polymer (SMP) with a first glass transition temperature, a second SMP with a second glass transition temperature different than the first glass transition temperature, and a third SMP with a third glass transition temperature different than the first glass transition temperature and the second glass transition temperature. The morphing load bearing structure also includes a sealing layer disposed on the auxetic pattern sheet. The plurality of fabric panels are formed from natural fiber fabric panels, polymer fabric panels, metal wool panels, and combinations thereof and the auxetic pattern sheet with the sealing layer is configured to be inflated into a complex shape without a wrinkle.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings, wherein:

FIG. 1A shows a top view of a fabric sheet with an auxetic pattern in a first shape;

FIG. 1B shows the fabric sheet in FIG. 1B in a second shape;

FIG. 2A shows a top view of shape memory polymer (SMP) impregnated fabric sheet with an auxetic pattern according to the teachings of the present disclosure;

FIG. 2B shows a cross-sectional view of section 2B-2B in FIG. 2A;

FIG. 3 is a graphical plot of elastic modulus as a function of temperature for four (4) SMPs with four different glass transition temperatures (t_{g});

FIG. 4A shows a cross-sectional view of the SMP impregnated fabric sheet in FIG. 2A at a predefined temperature T1 and subjected to a predefined pressure P1 according to one variation of the present disclosure;

FIG. 4B shows the SMP impregnated fabric sheet in FIG. 4A at a predefined temperature T2 and subjected to a predefined pressure P2;

FIG. 5A shows a cross-sectional view of the SMP impregnated fabric sheet in FIG. 2A at a predefined temperature T1 and subjected to a predefined pressure P1 according to another variation of the present disclosure;

FIG. 5B shows the SMP impregnated fabric sheet in FIG. 5A at a predefined temperature T2 and subjected to a predefined pressure P2;

FIG. 6A shows a cross-sectional view of the SMP impregnated fabric sheet in FIG. 2A at a predefined temperature T1 and subjected to a predefined pressure P1 according to still another variation of the present disclosure;

FIG. 6B shows the SMP impregnated fabric sheet in FIG. 6A at a predefined temperature T2 and subjected to a predefined pressure P2;

FIG. 7A shows the SMP impregnated fabric sheet in FIG. 2A at a predefined temperature T1 before being morphed into a desired shape around a computer mouse;

FIG. 7B shows the SMP impregnated fabric sheet in FIG. 7A at a predefined temperature T2 after being morphed into the desired shape around the computer mouse;

FIG. 7C shows the SMP impregnated fabric sheet in FIG. 7B at the predefined temperature T1 after being removed from the computer mouse;

FIG. 8A shows the SMP impregnated fabric sheet in FIG. 2A at a predefined temperature T1 and before being morphed into a desired shape around a coffee mug;

FIG. 8B shows the SMP impregnated fabric sheet in FIG. 8A at a predefined temperature T2 after being morphed into the desired shape around the coffee mug; and

FIG. 8C shows the SMP impregnated fabric sheet in FIG. 8B at the predefined temperature T1 after being removed from the coffee mug.

### DETAILED DESCRIPTION

The present disclosure provides a morphed load bearing structure formed from an auxetic pattern sheet. The auxetic pattern sheet includes a plurality of fabric panels (also referred to herein simply as “fabric panels”) selectively impregnated with a shape memory polymer (SMP). The morphed load bearing structure also includes a sealing layer disposed on or over the fabric panels. As used herein, the term “load bearing” refers to supporting a force from an external object (i.e., not air or gravity) applied to a structure, “impregnated” refers to a fabric panel has been soaked or saturated with an SMP and the phrase “selectively impregnated” refers to individual fabric panels having been independently impregnated with an SMP. Also, the phrase “shape memory polymer” refers to a polymer that can reversibly change shape in response to an external stimulus such as heat, light, electric field, and magnetic field, among others.

In some variations, the fabric panels are selectively impregnated with SMPs that have different glass transition temperatures. For example, in at least one variation, the fabric panels are selectively impregnated with a first SMP that has a first glass transition temperature and a second SMP that has a second glass transition temperature that is different than the first SMP. In addition, and when the auxetic pattern sheet is at a temperature greater than the first glass transition temperature but less than the second glass transition temperature, the auxetic pattern sheet is configured to morph into a complex shape. That is, the fabric panels impregnated with the first SMP having the first glass transition temperature morph into a first desired shape while the fabric panels impregnated with the second SMP having the second glass transition temperature either do not morph or morph into a second desired shape different than the first desired shape. As used herein, the phrase “complex shape” refers to a shape formed by the auxetic pattern sheet, the shape having an outer surface, and the outer surface having at least two different radii of curvature. And in some variations, and after the fabric panels impregnated with the first SMP have morphed into the desired shape, the temperature of the fabric panels is reduced to less that the first glass transition temperature and the auxetic pattern sheet provides a load bearing structure.

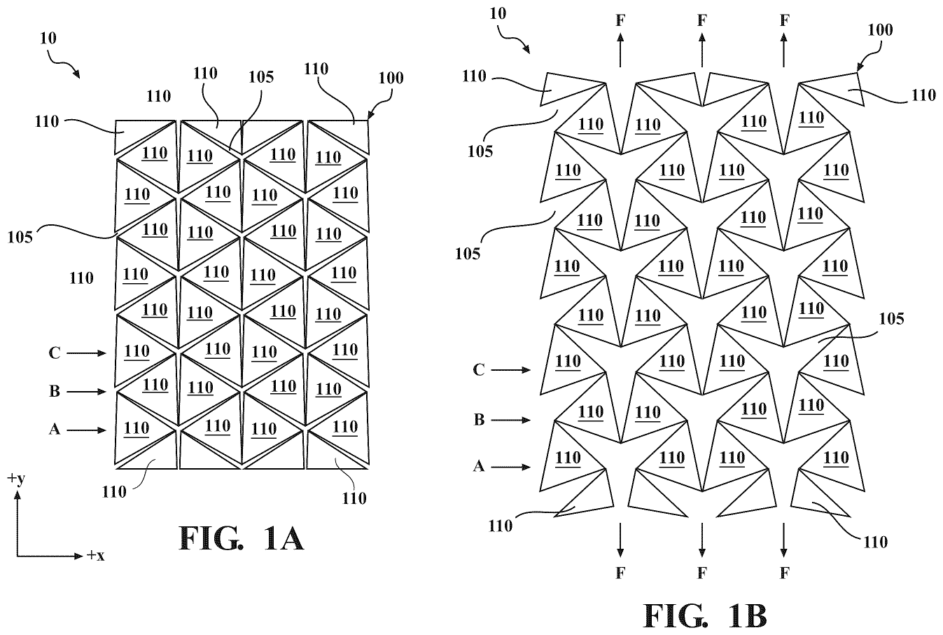

Referring to FIGS. 1A-1B, an auxetic pattern sheet 10 according to one form of the present disclosure is shown. The auxetic pattern sheet 10 includes a fabric layer 100 with a plurality of fabric panels 110 partially separated from each other by a plurality of slits 105. As used herein the phrase “auxetic pattern sheet” refers to a sheet of material having a structure (i.e., an auxetic pattern) that has a negative Poisson's ratio. For example, applying a force ‘F’ along the length (y-direction) of the auxetic pattern sheet 10 results in an increase of the width (x-direction) of the auxetic pattern sheet 10 as illustrated in FIG. 1B. Non limiting examples of auxetic pattern sheets 10 include re-entrant hexagonal pattern sheets, chiral pattern sheets, and a rotating squares pattern sheets, among others.

The plurality of fabric panels 110 are impregnated with an SMP, and in some variations, the plurality of fabric panels 110 are selectively impregnated with SMPs that have different glass transition temperatures. For example, a row (x-direction) of fabric panels labeled ‘A’ in FIGS. 1A-1B can be impregnated with a first SMP having a first glass transition temperature, a row of fabric panels labeled ‘B’ in FIGS. 1A-1B can be impregnated with a second SMP having a second glass transition temperature that is different than the first glass transition temperature, and a row (x-direction) of fabric panels labeled ‘C’ in FIGS. 1A-1B can be impregnated with a third SMP having a third glass transition temperature that is different than the first glass transition temperature and the second glass transition temperature. And while it should be understood that other fabric panel—SMP configurations are included in the teachings of the present disclosure, it should also be understood that the auxetic pattern sheet 10, and other auxetic pattern sheets disclosed herein, exhibit a negative Poisson's ratio.

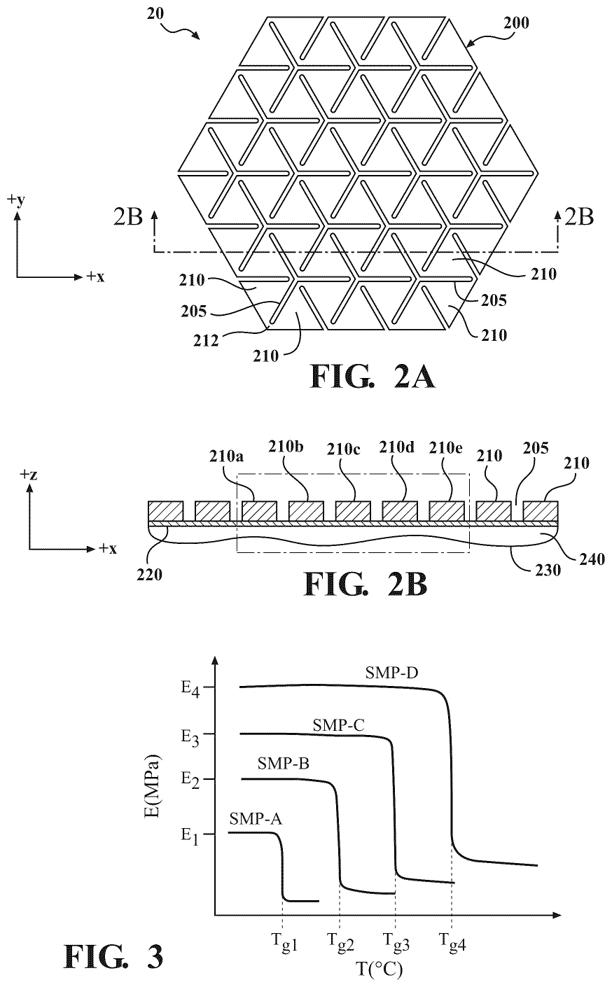

Referring now to FIGS. 2A-2B, a top view of an auxetic pattern sheet 20 according to another form of the present disclosure is shown in FIG. 2A and a cross-sectional view of section 2B-2B in FIG. 2A is shown in FIG. 2B. The auxetic pattern sheet 20 includes a fabric layer 200 with a plurality of fabric panels 210 partially separated from each other by a plurality of slits 205. That is, two adjacent fabric panels 210 include a joining portion 212 and a slit 205 extending from the joining portion 212 and between the two adjacent fabric panels 210. In some variations, a sealing layer 220 (FIG. 2B) is included and disposed on an inner surface (−z direction) of the fabric layer 200. In the alternative, or in addition to, in some variations a sealing layer 220 is disposed on an outer surface (+z direction) of the fabric layer 200 (not shown). The sealing layer 220 is “airtight,” i.e., the sealing layer 220 does not allow a gas (e.g., air, argon, nitrogen, etc.) or a liquid (e.g., water) to pass therethrough when measured over a time period of hours, days, months, and/or years. Accordingly, the auxetic pattern sheet 20 is airtight. In some variations, the sealing layer 220 is an elastomer layer.

In some variations, at least a portion (subset) of the fabric panels 210 are impregnated with an SMP. For example, and with reference to FIG. 2B, fabric panels 210a, 210b, 210c, 210d, and 210e (collectively referred to as fabric panels 210a-210e) are impregnated with an SMP. And while the following discussion refers to fabric panels 210a-210e being impregnated with an SMP, it should be understood that the fabric panels 210 adjacent (+/−x direction) to the fabric panels 210a-210e, and other fabric panels 210 of the fabric layer 200, may or may not be impregnated with an SMP and can be included within the teachings regarding fabric panels 210a-210e provided below.

Non-limiting examples of the fabric layer 200 include natural fiber layers, polymer fabric layers, metal wool layers, and combinations thereof, among others. Accordingly, the fabric panels 210 can be natural fiber fabric panels, polymer fabric panels, metal wool panels, and combinations thereof, among others. Also, non-limiting examples of SMPs used to impregnate the fabric panels 210 include polyepoxides, polytetrafluoroethylene (PTFE), polylactide (PLA), ethylene-vinyl acetate (EVA), crystalline trans-polyisoprene, and combinations thereof, among others.

In some variations, the fabric panels 210a-210e are selectively impregnated with SMPs having different glass transition temperatures. As used herein, the phrase “glass transition temperature” refers to the temperature or a range of temperatures for which a SMP transitions from a relatively hard or rigid state to a flexible or rubbery state, or vice-versa. For example, and with reference to FIG. 3, a graphical plot of four different SMPs with four different glass transition temperatures is shown. The SMP labeled “SMP-A” has an elastic modulus of E₁ at temperatures below T_{g1}, but the elastic modulus decreases rapidly at temperatures above T_{g1}. The SMP labeled “SMP-B” has an elastic modulus of E₂ at temperatures below T_{g2}, but decreases rapidly at temperatures above T_{g2}. The SMP labeled “SMP-C” has an elastic modulus of E₃ at temperatures below T_{g3}, but decreases rapidly at temperatures above T_{g3}, And the SMP labeled “SMP-D” has an elastic modulus of E₄ at temperatures below T_{g4}, but the elastic modulus decreases rapidly at temperatures above T_{g4}. Accordingly, the glass transitions temperatures for SMP-A, SMP-B, SMP-C, and SMP-D, are T_{g1}, T_{g2}, T_{g3}, and T_{g4}, respectively.

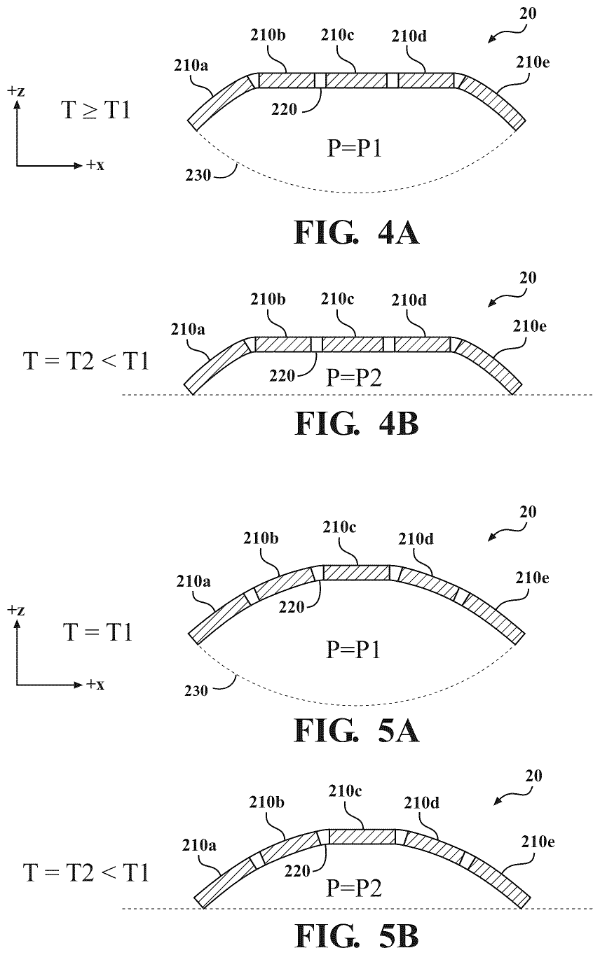

Referring now to FIGS. 4A-4B, one illustrative example of the auxetic pattern sheet 20 morphed into a desired shape is shown. Particularly, fabric panels 210a and 210e are impregnated with a SMP that has a glass transition temperature less than temperature T1 (e.g., SMP-A with T1=T_{g1}) and fabric panels 210b, 210c, and 210d are impregnated with a different SMP that has a glass transition temperature greater than temperature T1 (e.g., SMP-C). Accordingly, and as illustrated in FIG. 4A, when the auxetic pattern sheet 20 (i.e., the fabric panels 210) is heated to the temperature T1, and a pressure (force) P1 is applied to an inner (−z direction) surface of the fabric panels 210a-210e, the fabric panels 210a and 210e morph into a curved shape while the fabric panels 210b-210d remain in a planar shape (also referred to herein as a “planar section”). Stated differently, the fabric panels 210a, 210e transition from a relatively rigid state to a flexible or rubbery state such that the pressure P1 applied to the inner surface of the fabric panels 210a, 210e results in morphing thereof. In contrast, fabric panels 210b-210d remain in a rigid state at temperature T1 and thus do not morph into a different shape. In some variations, a bladder 230 is included with the auxetic pattern sheet 20 and used to contain a gas or liquid such that the pressure P1 can be applied to the inner surface of the panels 210a-210e.

Referring particularly to FIG. 4B, when the auxetic pattern sheet 20 is cooled to temperature T2, which is less than T1, the fabric panels 210a and 210e return to a rigid state while maintaining the curved shape and thus are “frozen” into the shape illustrated in FIG. 4A and the auxetic pattern sheet 20 becomes a load ‘L’ bearing structure with a predefined shape. In some variations, the pressure is reduced to a predefined pressure P2, e.g., atmospheric pressure. It should be understood that heating the auxetic pattern sheet 20 to a temperature above the glass transition temperature of the SMP used to impregnate the fabric panels 210a-210e will result in the auxetic pattern sheet returning to a flat planar shape as shown in FIGS. 2A-2B when and/or if a force (e.g., gravity) is applied to the fabric panels 210b, 210c, 210d. Accordingly, the auxetic pattern 20 illustrated in FIGS. 4A-4B can be reversibly morphed between a first shape (e.g., FIGS. 2A-2B) and a second shape (e.g., FIG. 4B).

Referring now to FIGS. 5A-5B, another illustrative example of the auxetic pattern sheet 20 morphed into a desired shape is shown. Particularly, fabric panels 210a, 210b, 210d, and 210e are impregnated with a SMP that has a glass transition temperature less than temperature T1 (e.g., SMP-A with T1=T_{g1}) and fabric panel 210c is impregnated with a different SMP that has a glass transition temperature greater than temperature T1 (e.g., SMP-C). Accordingly, and as illustrated in FIG. 5A, when the auxetic pattern sheet 20 (i.e., the fabric panels 210) is heated to the temperature T1, and a pressure (force) P1 is applied to an inner (−z direction) surface of the fabric panels 210a-210e, the fabric panels 210a, 210b, 210d, and 210e morph into a curved shape while the fabric panel 210c remains in a planar shape. Stated differently, the fabric panels 210a, 210b, 210d, 210e transition from a relatively rigid state to a flexible or rubbery state such that the pressure P1 applied to the inner surface of the fabric panels 210a, 210b, 210d, 210e results in morphing thereof. In contrast, the fabric panel 210c remains in a rigid state at temperature T1 and thus does not morph into a different shape.

Referring particularly to FIG. 5B, when the auxetic pattern sheet 20 is cooled to temperature T2, which less than T1, the fabric panels 210a, 210b, 210d, 210e return to a rigid state while maintaining the curved shape and thus are “frozen” into the shape illustrated in FIG. 5A and the auxetic pattern sheet 20 becomes a load ‘L’ bearing structure. In some variations, the pressure is reduced to a predefined pressure P2, e.g., atmospheric pressure. It should be understood that heating the auxetic pattern sheet 20 to a temperature above the glass transition temperature of the SMP used to impregnate the fabric panels 210a, 210b, 210d, 210e will result in the auxetic pattern sheet returning to a flat planar shape as shown in FIGS. 2A-2B when and/or if a force (e.g., gravity) is applied to the fabric panels 210a, 210b, 210d, 210e. Accordingly, the auxetic pattern 20 illustrated in FIGS. 5A-5B can be reversibly morphed between a first shape (e.g., FIGS. 2A-2B) and a second shape (e.g., FIG. 5B).

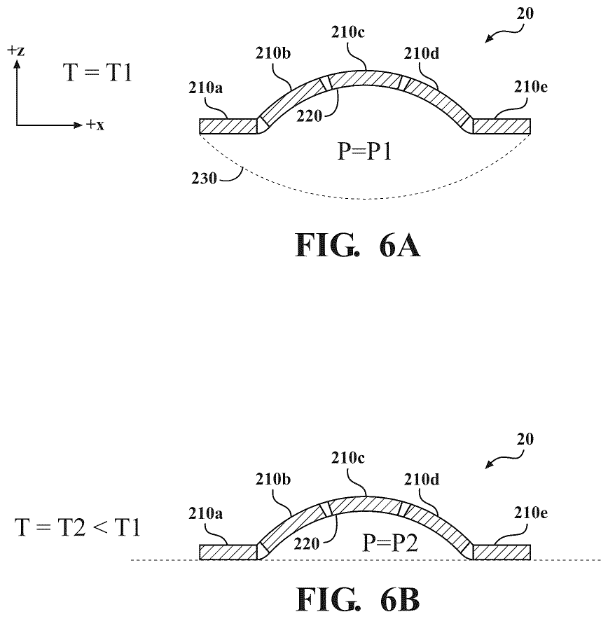

Referring now to FIGS. 6A-6B, still another illustrative example of the auxetic pattern sheet 20 morphed into a desired shape is shown. Particularly, fabric panels 210b, 210c, and 210d are impregnated with a SMP that has a glass transition temperature less than temperature T1 (e.g., SMP-A with T1=T_{g1}) and fabric panels 210a and 210e are impregnated with a different SMP that has a glass transition temperature greater than temperature T1 (e.g., SMP-C). Accordingly, and as illustrated in FIG. 6A, when the auxetic pattern sheet 20 (i.e., the fabric panels 210) is heated to the temperature T1, and a pressure (force) P1 is applied to an inner (−z direction) surface of the fabric panels 210a-210e, the fabric panels 210b, 210c, and 210d morph into a curved shape while the fabric panels 210a and 210e remain in a planar shape. Stated differently, the fabric panels 210b, 210c, 210d transition from a relatively rigid state to a flexible or rubbery state such that the pressure P1 applied to the inner surface of the fabric panels 210b, 210c, 210d results in morphing thereof. In contrast, the fabric panels 210a, 210e remains in a rigid state at temperature T1 and thus do not morph into a different shape.

Referring particularly to FIG. 6B, when the auxetic pattern sheet 20 is cooled to temperature T2, which is less than T1, the fabric panels 210b, 210c, 210d, return to a rigid state while maintaining the curved shape and thus are “frozen” into the shape illustrated in FIG. 6A and the auxetic pattern sheet 20 becomes a load ‘L’ bearing structure. In some variations, the pressure is reduced to a predefined pressure P2, e.g., atmospheric pressure. It should be understood that heating the auxetic pattern sheet 20 to a temperature above the glass transition temperature of the SMP used to impregnate the fabric panels 210b, 210c, 210d will result in the auxetic pattern sheet returning to a flat planar shape as shown in FIGS. 2A-2B when and/or if a force (e.g., gravity) is applied to the fabric panels 210b, 210c, 210d. Accordingly, the auxetic pattern 20 illustrated in FIGS. 6A-6B can be reversibly morphed between a first shape (e.g., FIGS. 2A-2B) and a second shape (e.g., FIG. 6B).

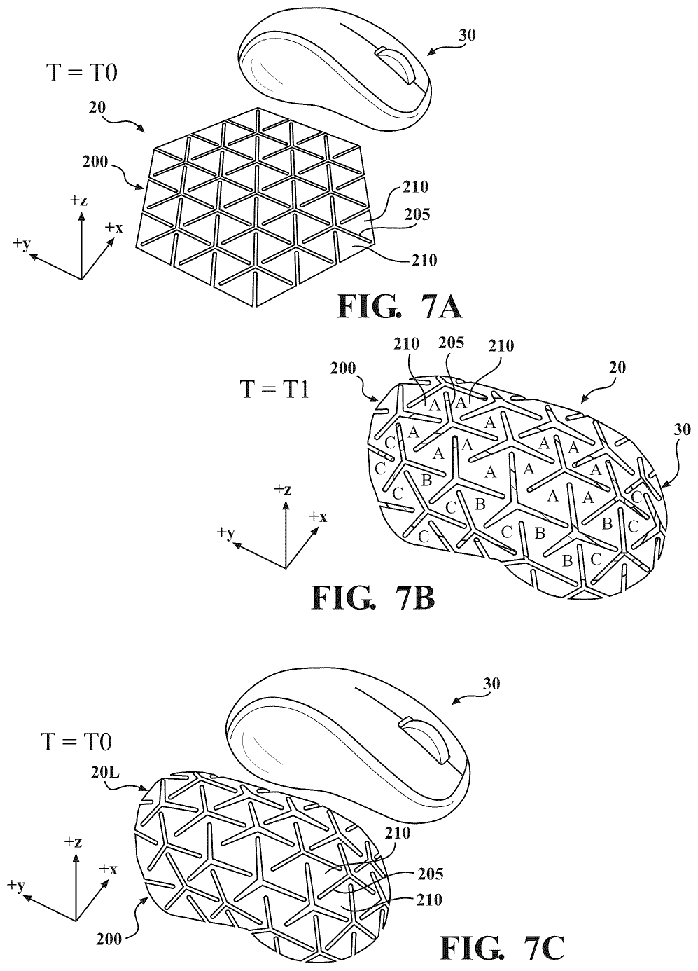

Referring now to FIGS. 7A-7C, morphing of the auxetic pattern sheet 20 into a load bearing structure 20L is shown. All of the fabric panels 210 are impregnated with an SMP and in some variations the fabric panels 210 are selectively impregnated with SMPs that have different glass transition temperatures. FIG. 7A illustrates the auxetic pattern 20 in a first shape at a temperature T0 that is below or less than the glass transition of the SMP or any of the SMPs used to impregnate the fabric panels 210. FIG. 7A also illustrates an object or die 30 with the shape of a computer mouse.

In variations where all of the fabric panels 210 are impregnated with a single SMP (e.g., SMP-A), FIG. 7B illustrates the auxetic pattern sheet 20 having been heated to a temperature greater than the glass transition temperature of the SMP (e.g., T>T_{g1}) and a force having been applied to an outer surface (+z direction in FIG. 7A) of the fabric layer 200 such that the fabric panels 210 morph into a shape of the object 30. And FIG. 7C illustrates the auxetic pattern sheet 20 having been cooled to a temperature less than T_{g1} such that the fabric panels 210 return to a rigid state and a load bearing structure is provided. In this manner the auxetic pattern sheet 20 is reversibly morphed into a complex load bearing shape without wrinkles. Also, it should be understood that a force (pressure) can be applied to an inner force of the fabric layer 200 as discussed above with respect to FIGS. 4A-6B.

In variations where the fabric panels 210 are selectively impregnated with two or more SMPs (e.g., SMP-A, SMP-B, SMP-C), FIG. 7B illustrates the auxetic pattern sheet 20 having been heated in stages to temperatures greater than the glass transition temperatures of the two or more SMPs (e.g., T1>T_{g1}) and a force or forces having been applied to an outer surface (+z direction in FIG. 7A) of the fabric layer 200 such that the fabric panels 210 morph, in stages, into a shape of the object 30. For example, the fabric panels labeled ‘A’ in FIG. 7B can be impregnated with SMP-A with the glass transition temperature T_{g1}, the fabric panels labeled ‘B’ can be impregnated with SMP-B with the glass transition temperature T_{g2}, and the fabric panels labeled ‘C’ can be impregnated with SMP-C with the glass transition temperature T_{g3}. In addition, and while a predefined force is applied to the outer surface of the fabric layer 200, the auxetic pattern sheet 20 can be heated to a temperature greater than Tg1 but less than Tg2 and Tg3 such that the fabric panels labeled A morph into the shape shown in FIG. 7B, then the auxetic pattern sheet 20 can be heated to a temperature greater than Tg2 but less than Tg3 such that the fabric panels labeled B morph into the shape shown in FIG. 7B, and then the auxetic pattern sheet 20 can be heated to a temperature greater than Tg3 such that the fabric panels labeled C morph into the shape shown in FIG. 7B. In this manner, the auxetic pattern sheet 20 is reversibly morphed into a complex load bearing shape without wrinkles. Also, it should be understood that a force (pressure) can be applied to an inner force of the fabric layer 200 as discussed above with respect to FIGS. 4A-6B.

As used herein, the phrase “without wrinkles” refers to an inner and/or outer surface of the auxetic pattern sheet has/have an uninterrupted surface continuity. That is, the sealing layer 220 provides a continuous inner surface and/or outer surface between adjacent fabric panels 210. In some variations, the sealing layer 220 provides a continuous inner surface and/or outer surface between adjacent fabric panels 210 such that the slits 205 are not felt and/or seen by an individual using a rigid state and a load bearing structure provided by the auxetic pattern sheet 20.

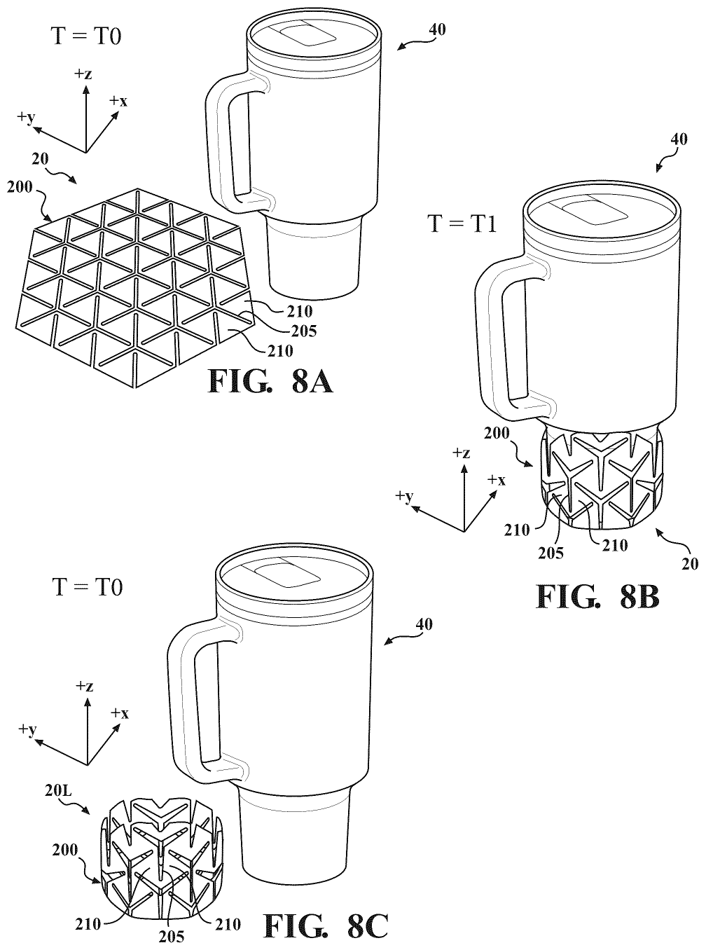

Referring now to FIGS. 8A-8C, morphing of the auxetic pattern sheet 20 into another load bearing structure 20L is shown. All of the fabric panels 210 are impregnated with an SMP and in some variations the fabric panels 210 are selectively impregnated with SMPs that have different glass transition temperatures. FIG. 8A illustrates the auxetic pattern 20 in a first shape at a temperature T0 that is below or less than the glass transition of the SMP or any of the SMPs used to impregnate the fabric panels 210. FIG. 8A also illustrates an object or die 40 with the shape of a coffee mug or water bottle.

In variations where all of the fabric panels 210 are impregnated with a single SMP (e.g., SMP-A), FIG. 8B illustrates the auxetic pattern sheet 20 having been heated to a temperature greater than the glass transition temperature of the SMP (e.g., T1>T_{g1}) and a force having been applied to an inner surface (−z direction in FIG. 8A) of the fabric layer 200 such that the fabric panels 210 morphs into a shape of the object 40. And FIG. 8C illustrates the auxetic pattern sheet having been cooled to a temperature less than T_{g1} such that the fabric panels 210 return to a rigid state and a load bearing structure in the form of a cup holder is provided. In this manner the auxetic pattern sheet 20 is reversibly morphed into a complex load bearing shape without wrinkles. Stated differently, the auxetic pattern 20 can be morphed into a cup holder for a given coffee mug and then heated and morphed into a cup holder for a different size coffee mug. It should be understood that the fabric panels can be selectively impregnated with two or more SMPs as described above with respect to FIGS. 7A-7C such that the auxetic pattern sheet can be morphed into a desired complex load bearing shape in stages.

While described as methods and illustrated with flowcharts, it should be understood that the present disclosure provides for systems that execute the methods described herein. For example, a system disclosed herein can include a processor, a memory communicably coupled to the processor and storing machine-readable instructions that, when executed by the processor, cause the processor to perform the methods and/or method steps disclosed herein, among others.

The preceding description is merely illustrative in nature and is in no way intended to limit the disclosure, its application, or uses. Work of the presently named inventors, to the extent it may be described in the background section, as well as aspects of the description that may not otherwise qualify as prior art at the time of filing, are neither expressly nor impliedly admitted as prior art against the present technology.

As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple variations or forms having stated features is not intended to exclude other variations or forms having additional features, or other variations or forms incorporating different combinations of the stated features.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one variation, or various variations means that a particular feature, structure, or characteristic described in connection with a form or variation, or particular system is included in at least one variation or form. The appearances of the phrase “in one variation” (or variations thereof) are not necessarily referring to the same variation or form. It should also be understood that the various method steps discussed herein do not have to be carried out in the same order as depicted, and not each method step is required in each variation or form.

The foregoing description of the forms and variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

What is claimed is:

1. A morphing load bearing structure comprising:
an auxetic pattern sheet formed from a plurality of fabric panels selectively impregnated with a first shape memory polymer (SMP) with a first glass transition temperature and a second SMP with a second glass transition temperature different than the first glass transition temperature; and
a sealing layer disposed on the auxetic pattern sheet such that the auxetic pattern sheet is configured to be inflated into a complex shape without a wrinkle.

2. The morphing load bearing structure according to claim 1 further comprising a bladder attached to the auxetic pattern sheet such that the auxetic pattern sheet with the bladder attached thereto is configured to contain a pressurized fluid therein.

3. The morphing load bearing structure according to claim 1, wherein the plurality of fabric panels is selected from the group consisting of natural fiber fabric panels, polymer fabric panels, metal wool panels, and combinations thereof.

4. The morphing load bearing structure according to claim 1, wherein the first SMP and the second SMP are independently selected from the group consisting of polyepoxides, polytetrafluoroethylene (PTFE), polylactide (PLA), ethylene-vinyl acetate (EVA), crystalline trans-polyisoprene, and combinations thereof.

5. The morphing load bearing structure according to claim 1, wherein the sealing layer is an elastomer layer.

6. The morphing load bearing structure according to claim 1, wherein the auxetic pattern sheet, when inflated, comprises an outer surface with at least one planar section.

7. The morphing load bearing structure according to claim 1, wherein the plurality of fabric panels are selectively impregnated with the first SMP, the second SMP, and a third SMP with a third glass transition temperature different than the first glass transition temperature and the second glass transition temperature.

8. The morphing load bearing structure according to claim 7, wherein the plurality of fabric panels are selectively impregnated with the first SMP, the second SMP, the third SMP, and a fourth SMP with a fourth glass transition temperature different than the first glass transition temperature, the second glass transition temperature, and the third glass transition temperature.

9. The morphing load bearing structure according to claim 1, wherein the auxetic pattern sheet is selected from the group consisting of a re-entrant hexagonal pattern sheet, a chiral pattern sheet, and a rotating squares pattern sheet.

10. A morphing load bearing structure comprising:
an auxetic pattern sheet formed from a plurality of fabric panels selectively impregnated with a first shape memory polymer (SMP) with a first glass transition temperature and a second SMP with a second glass transition temperature different than the first glass transition temperature;
an elastomer sealing layer disposed on the auxetic pattern sheet such that the auxetic pattern sheet is configured to be inflated into a complex shape without a wrinkle; and
a bladder attached to the auxetic pattern sheet such that the auxetic pattern sheet with the bladder attached thereto is configured to contain a pressurized fluid therein.

11. The morphing load bearing structure according to claim 10, wherein the plurality of fabric panels is selected from the group consisting of natural fiber fabric panels, polymer fabric panels, metal wool panels, and combinations thereof.

12. The morphing load bearing structure according to claim 10, wherein the first SMP and the second SMP are independently selected from the group consisting of polyepoxides, polytetrafluoroethylene (PTFE), polylactide (PLA), ethylene-vinyl acetate (EVA), crystalline trans-polyisoprene, and combinations thereof.

13. The morphing load bearing structure according to claim 10, wherein the auxetic pattern sheet, when inflated, comprises an outer surface with at least one planar section.

14. The morphing load bearing structure according to claim 10, wherein the plurality of fabric panels are selectively impregnated with the first SMP, the second SMP, and a third SMP with a third glass transition temperature different than the first glass transition temperature and the second glass transition temperature.

15. The morphing load bearing structure according to claim 14, wherein the plurality of fabric panels are selectively impregnated with the first SMP, the second SMP, the third SMP, and a fourth SMP with a fourth glass transition temperature different than the first glass transition temperature, the second glass transition temperature, and the third glass transition temperature.

16. The morphing load bearing structure according to claim 10, wherein the auxetic pattern sheet is selected from the group consisting of a re-entrant hexagonal pattern sheet, a chiral pattern sheet, and a rotating squares pattern sheet.

17. A morphing load bearing structure comprising:
an auxetic pattern sheet formed from a plurality of fabric panels selectively impregnated with a first shape memory polymer (SMP) with a first glass transition temperature, a second SMP with a second glass transition temperature different than the first glass transition temperature, and a third SMP with a third glass transition temperature different than the first glass transition temperature and the second glass transition temperature, the plurality of fabric panels selected from the group consisting of natural fiber fabric panels, polymer fabric panels, metal wool panels, and combinations thereof; and
a sealing layer disposed on the auxetic pattern sheet such that the auxetic pattern sheet is configured to be inflated into a complex shape without a wrinkle.

18. The morphing load bearing structure according to claim 17, wherein the first SMP, the second SMP, and the third SMP are independently selected from the group consisting of polyepoxides, polytetrafluoroethylene (PTFE), polylactide (PLA), ethylene-vinyl acetate (EVA), crystalline trans-polyisoprene, and combinations thereof.

19. The morphing load bearing structure according to claim 17, wherein the sealing layer is an elastomer layer.

20. The morphing load bearing structure according to claim 17, wherein the auxetic pattern sheet, when inflated, comprises an outer surface with at least one planar section.
